(19) United States
(12) Patent Application Publication
(10) Pub. No.: US 2026/0004083 A1
(43) Pub. Date: Jan. 1, 2026

(54) BUILDING LINGUISTIC OPERATIONAL EXPERT SYSTEMS FOR DNS, DHCP, AND IPAM (DDI)

(71) Applicant: Infoblox Inc., Santa Clara, CA (US)

(72) Inventors: Turner Anderson, Akron, OH (US); Mark Edward Peterson, Barrington, IL (US); Fatemeh Riahi, Burnaby (CA)

(21) Appl. No.: 18/806,400

(22) Filed: Aug. 15, 2024

Related U.S. Application Data
(60) Provisional application No. 63/664,591, filed on Jun. 26, 2024.

(51) Int. Cl. G06F 40/35; H04L 41/14

(52) U.S. Cl. CPC G06F 40/35; H04L 41/14

(57) ABSTRACT

Various techniques for building linguistic operational expert systems for DNS, DHCP, and IPAM (DDI) are disclosed. In some embodiments, a system/process/computer program product for building linguistic operational expert systems for DNS, DHCP, and IPAM (DDI) includes receiving a user request for DNS, DHCP, and IPAM (DDI) related information; processing the user request using a Large-Language Model (LLM); and generating a user interface (UI) output using the LLM and a vector embedding space, wherein the output includes generative UI content that was generated using the LLM and one or more relevant technical documentation for DDI related information that was selected based on a proximity to the user request in the vector embedding space.

### CROSS REFERENCE TO OTHER APPLICATIONS

This application claims priority to U.S. Provisional Patent Application No. 63/664,591 entitled BUILDING LINGUISTIC OPERATIONAL EXPERT SYSTEMS FOR DNS, DHCP, AND IPAM (DDI) filed Jun. 26, 2024, which is incorporated herein by reference for all purposes.

### BACKGROUND OF THE INVENTION

Domain Name System network services are generally ubiquitous in IP-based networks. Generally, a client (e.g., a computing device) attempts to connect to a server(s) over the Internet by using web addresses (e.g., Uniform Resource Locators (URLs) including domain names or fully qualified domain names). Web addresses are translated into IP addresses. The Domain Name System (DNS) is responsible for performing this translation from web addresses into IP addresses. Specifically, requests including web addresses are sent to DNS servers that generally reply with corresponding IP addresses or with an error message in case the domain has not been registered, a non-existent domain.

### BRIEF DESCRIPTION OF THE DRAWINGS

Various embodiments of the invention are disclosed in the following detailed description and the accompanying drawings.

FIG. 1 illustrates a block diagram of an architecture for building linguistic operational expert systems (Bloxy) for DNS, DHCP, and IPAM (DDI) in accordance with some embodiments.

FIG. 2 is a flow diagram for providing Bloxy for DDI in accordance with some embodiments.

FIGS. 3A-3F illustrate various prompts for prompt engineering of LLMs for implementing Bloxy for DDI in accordance with some embodiments.

FIGS. 4A-4C illustrate screen diagrams generated using Bloxy for DDI in accordance with some embodiments.

FIG. 5 is a flow diagram of a process using the Bloxy for DDI solution in accordance with some embodiments.

FIG. 6 is another flow diagram of a process using the Bloxy for DDI solution in accordance with some embodiments.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

Domain Name System network services are generally ubiquitous in IP-based networks. Generally, a client (e.g., a computing device) attempts to connect to a server(s) over the Internet by using web addresses (e.g., Uniform Resource Locators (URLs) including domain names or fully qualified domain names (FQDNs)). Web addresses are translated into IP addresses. The Domain Name System (DNS) is responsible for performing this translation from web addresses into IP addresses. Specifically, requests including web addresses are sent to DNS servers that generally reply with corresponding IP addresses or with an error message in case the domain has not been registered, a non-existent domain (e.g., an NX Domain response is returned by DNS servers for a non-existent domain).

The Domain Name System (DNS) is a globally distributed database that provides core functionality for the operation of the Internet and local intranets. In particular, DNS provides the ability to locate Internet resource information, for example, IP addresses for domain names. The distributed nature of the DNS allows this resource information to be updated dynamically and controlled by the resource holders. To locate the current information, a client device, for example, a laptop, queries the DNS via a standard protocol. In practice, client devices do not perform the database lookup, referred to as resolution, themselves, but depend on other specialized servers to act on their behalf. These servers are called DNS recursive resolvers (e.g., a DNS recursor), and they are able to expedite the resolution of DNS records for a large number of clients through caching and optimized software. Recursive resolvers can also enact policies, for example, to limit client access to the Internet or specific resources.

### Technical Challenges for DNS Management

DNS, DHCP, and IPAM (DDI) are essential to the functioning of modern networks, and there are several existing solutions that attempt to simplify their management. DDI generally allows an entity (e.g., a corporate entity, an educational entity, a government entity, and/or other entities) to connect their devices to one another and the Internet, manage IP addresses assigned to devices, and efficiently manage subnets or IP address spaces. Several technology companies, such as Infoblox (e.g., offering commercially available solutions, such as BloxOne/NIOS), Amazon (e.g., offering commercially available solutions, such as Route 53), and Microsoft (e.g., offering commercially available solutions, such as DNS Server) offer different types of solutions in order to minimize the level of effort necessary to efficiently manage a network.

However, the existing solutions for network management are still considered expert systems. For example, the existing solutions generally require significant training to leverage the capabilities fully.

As such, new and improved solutions for network management are needed.

### Overview of Techniques for Building Linguistic Operational Expert Systems (Bloxy) for DNS, DHCP, and IPAM (DDI)

Accordingly, various techniques for building linguistic operational expert systems for DNS, DHCP, and IPAM (DDI) (e.g., also referred to herein as an acronym of Bloxy for DDI) are disclosed.

In some embodiments, a system/process/computer program product for building linguistic operational expert systems (Bloxy) for DNS, DHCP, and IPAM (DDI) includes receiving a user request for DNS, DHCP, and IPAM (DDI) related information; processing the user request using a Large-Language Model (LLM); and generating a user interface (UI) output using the LLM and a vector embedding space, wherein the output includes generative UI content that was generated using the LLM and one or more relevant technical documentation for DDI related information that was selected based on a proximity to the user request in the vector embedding space.

For example, the user request can include a user query for DDI related information associated with the user's enterprise network, and the DDI related information can include customer information, such as various network configuration information, network event data, and/or telemetry and log data. Also, a conversation history can be stored for a plurality of user requests, such as will be further described below.

In some embodiments, an embedding model is used for determining relevant DDI documentation based on the user request, such as will be further described below.

In some embodiments, the UI output includes one or more of the following interactive elements: clickable responses, clickable follow-up questions, tables, graphs, and widgets, such as will be further described below.

For example, the UI output includes a UI widget (e.g., or another UI element) for user input, and can then perform an action using the Bloxy for DDI solution based on the user input in the UI widget, such as will be further described below.

In some embodiments, a system/process/computer program product for Bloxy for DDI further includes processing a conversation history and generating a query or a message that incorporates a relevant context using the LLM.

In some embodiments, a system/process/computer program product for Bloxy for DDI further includes classifying an intent associated with the user request using the LLM.

In some embodiments, a system/process/computer program product for Bloxy for DDI further includes performing retrieval augmented generation for using a vector database for DDI related technical documentation.

These and other aspects and embodiments for building linguistic operational expert systems for DNS, DHCP, and IPAM (DDI) will now be further described below.

### Example Embodiments for Building Linguistic Operational Expert Systems for DNS, DHCP, and IPAM (DDI)

Thus, new and improved techniques for building linguistic operational expert systems for DNS, DHCP, and IPAM (DDI) are disclosed.

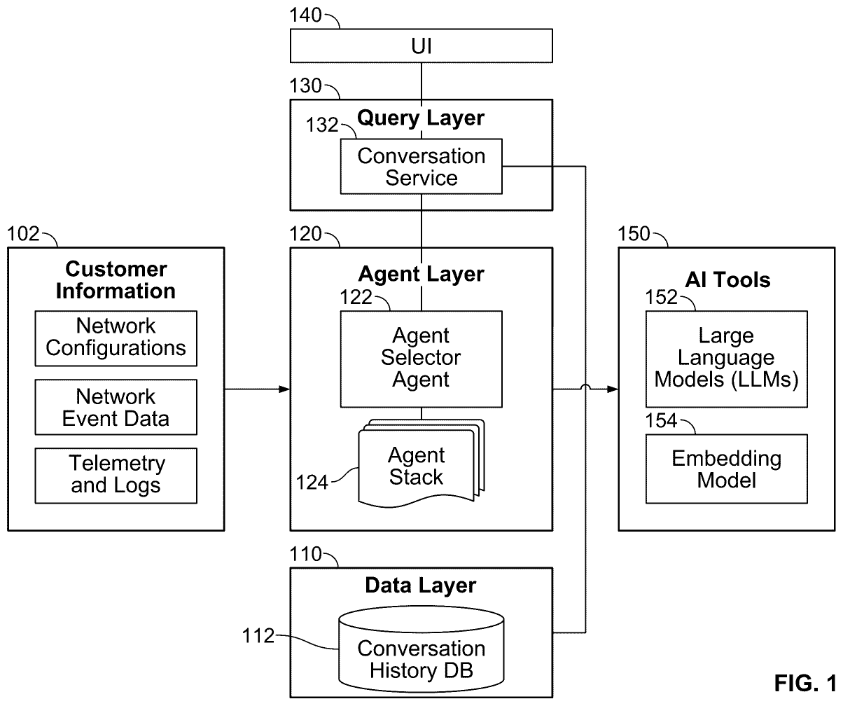

FIG. 1 illustrates a block diagram of an architecture for building linguistic operational expert systems (Bloxy) for DNS, DHCP, and IPAM (DDI) in accordance with some embodiments. Specifically, a new solution referred to herein as Bloxy for DDI is disclosed as will now be described below with respect to FIG. 1.

Referring to FIG. 1, in this example implementation, the architecture for Bloxy for DDI includes providing customer information 102 to an agent layer 120. The customer information can include network configuration information, network event data, and/or telemetry and log related data as shown in FIG. 1.

As also shown in FIG. 1, a query layer 130 includes a conversation service 132. The conversation service receives user queries, such as user queries for DDI for related information (e.g., network configuration, network event, and/or telemetry/log related DDI information). The query layer is in communication with an agent layer 120. As shown, the agent layer includes an agent selector agent 122 that selects agents from an agent stack as shown at 124. The conversation service is also in communication with a data layer 110 that stores conversation history data in a conversation history data store, shown as conversation history database 112.

The agent layer is in communication with Artificial Intelligence (AI) tools as shown at 150. The AI tools include Large Language Models (LLMs) 152 and an embedding model 154. As further described herein, the AI tools can be used to process (e.g., parse) the user query (e.g., user requests) and to automatically generate responses that can be output via a user interface (UI) as shown at 140. The AI tools can utilize any LLM, Small Language Models (SLMs), and/or embedding models. In an example implementation, for an LLM, the Azure OpenAI GPT3.5-Turbo or the Azure OpenAI GPT4-Turbo commercially available LLMs can be utilized; and for an embedding model, the Azure OpenAI ADA 002 commercially available embedding model can be utilized (e.g., or other publicly/commercially available LLMs, SLMs, and/or embedding models can similarly be utilized as will be apparent in view of the disclosed embodiments as further described below).

In this example implementation, Bloxy for DDI includes a conversational assistant embedded with product knowledge and best practices, queryable network data, configuration capabilities, and personalization opportunities. As such, the disclosed Bloxy for DDI solution reduces substantially the expertise required to service a network, and enables unsophisticated users to deliver insights that would have formerly been out of reach. For example, the disclosed Bloxy for DDI solution can serve multiple personas in the networking ecosystem, simplifying the job of network engineers while aiding security operation centers (SOCs) in delivering insights and monitoring network events.

In this example implementation, Bloxy for DDI utilizes LLMs (e.g., and/or SLMs as discussed above) and vector embedding models to parse user requests and automatically generate responses. However, existing LLMs have several technical challenges. For example, a significant problem with existing LLMs is their tendency to hallucinate, in which LLMs can confidently generate answers to user queries that are incorrect (e.g., include factually incorrect information/responses). Additionally, existing LLMs have trouble with certain technical problems, such as math, aggregations, and API requests.

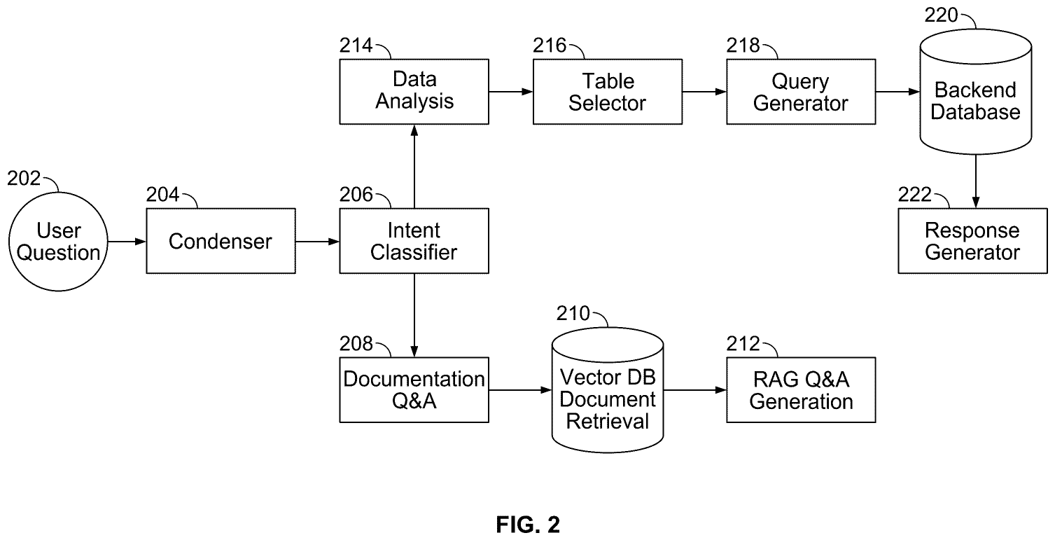

As such, to avoid these technical challenges, Bloxy for DDI does not solely rely on LLMs to respond to queries autonomously. Rather, the disclosed Bloxy for DDI solution uses LLMs to determine user intents (e.g., such as further described below with respect to FIG. 2), to respond within very tight constraints, and allow interactions in many languages that would otherwise require significant localization overhead.

In addition, vector embedding models are utilized in order to perform Retrieval Augmented Generation (RAG) to find existing documents related to incoming queries and present them as necessary context for question answering for the LLMs (e.g., such as further described below with respect to FIG. 2). For example, the disclosed Bloxy for DDI solution can also translate plain language questions into the requisite syntax for querying of databases to make use of customer data in the form of network configurations, network events, security events, telemetry, and logs.

Further, the disclosed Bloxy for DDI solution retains a memory of previous messages using the conversation database. The conversation history data facilitates the disclosed Bloxy for DDI to learn the habits and behaviors of each individual user, and personalize the experience accordingly, such as will be further described below.

FIG. 2 is a flow diagram for providing Bloxy for DDI in accordance with some embodiments. In an example implementation, the process illustrated in FIG. 2 can be implemented using the components and architecture as shown in FIG. 1 as described above.

Referring to FIG. 2, at 202, a user question (e.g., a user query for DDI related information) is received.

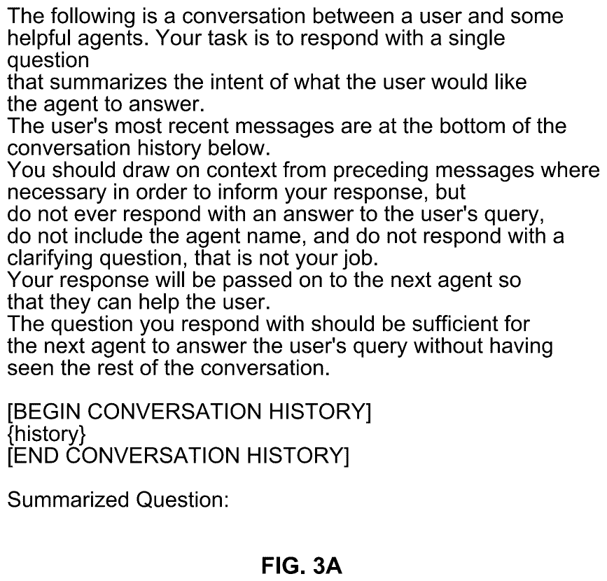

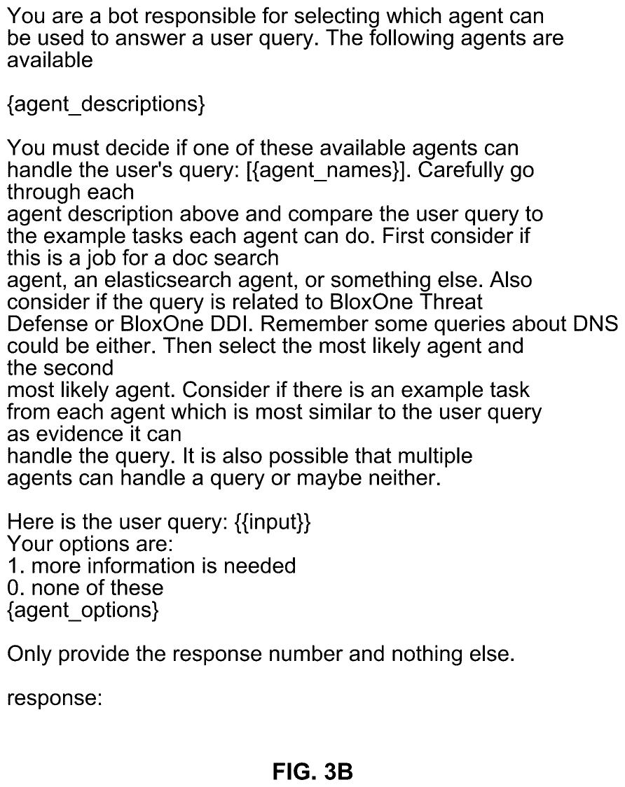

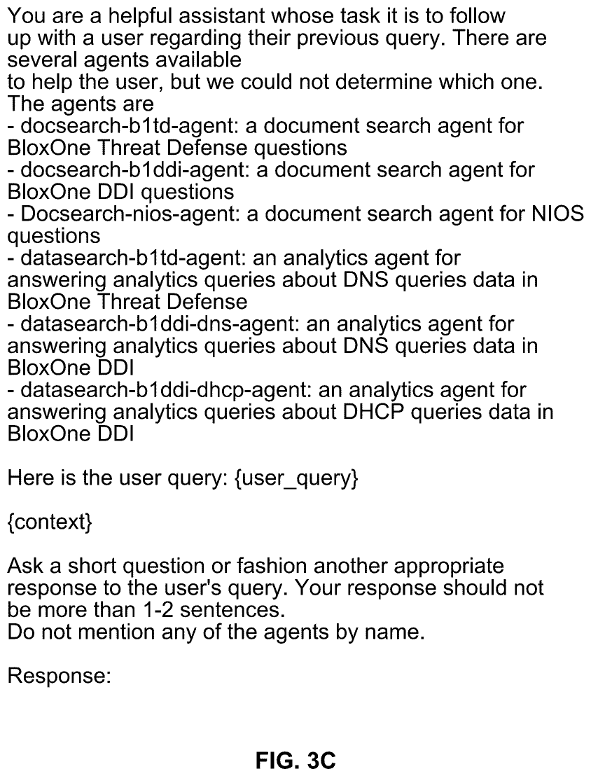

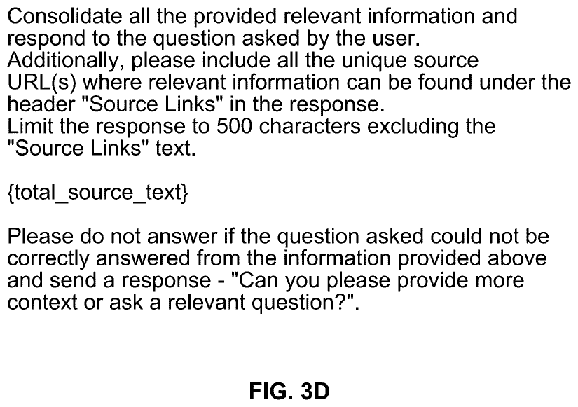

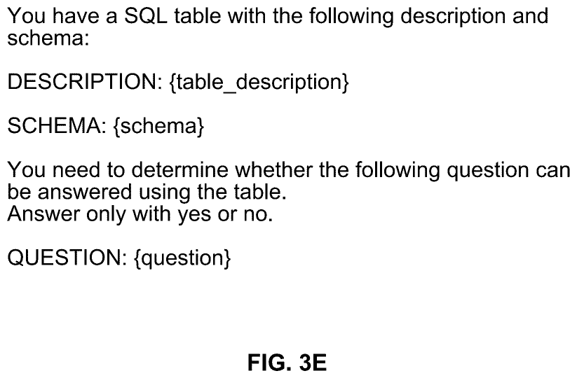

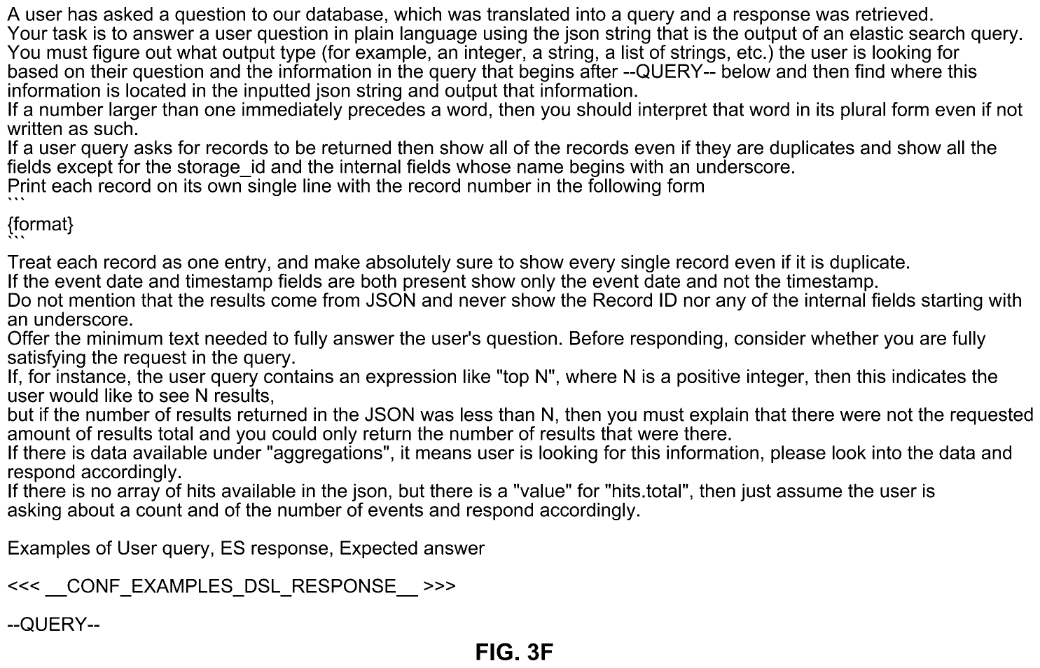

At 204, a condenser operation is performed. For example, the condenser can process the conversation history and generate a query or a message that incorporates the relevant context (e.g., using one question/query as input). An example prompt for prompt engineering of LLMs for the condenser operation is shown in FIG. 3A.

At 206, an intent classifier operation is performed. In an example implementation, the disclosed Bloxy for DDI solution uses LLMs to determine user intents (e.g., such as using the LLMs as similarly described above with respect to FIG. 1), to respond within very tight constraints, and allow interactions in many languages that would otherwise require significant localization overhead. An example prompt for prompt engineering of LLMs for the intent classifier operation is shown in FIG. 3B.

At 208, the results of the intent classifier are used to query documentation (e.g., DDI related documentation as similarly described above). Specifically, at 210, a vector database (DB) for document retrieval is used to retrieve the relevant documentation using RAG question and answer (Q&A) generation as shown at 212. An example prompt for prompt engineering of LLMs for the RAG Q&A generation operation is shown in FIG. 3D. In an example implementation, vector embedding models (e.g., as shown at 154 in FIG. 1) are utilized in order to perform Retrieval Augmented Generation (RAG) to find existing documents related to incoming queries and present them as necessary context for question answering for the LLMs (e.g., such as similarly described above with respect to FIG. 1). For example, the disclosed Bloxy for DDI solution can also translate plain language questions into the requisite syntax for querying of databases to make use of customer data in the form of network configurations, network events, security events, telemetry, and logs.

At 214, the results of the intent classifier are used to perform data analysis. An example prompt for prompt engineering of LLMs for the intent classifier operation is shown in FIG. 3B.

At 216, based on the results of the data analysis operation(s), a table selector (e.g., implemented using LLM-applied tags for filtering and LLMs for final decision making) is performed to select the relevant tables to query from one or more backend databases as shown at 220. An example prompt for prompt engineering of LLMs for the table selector operation is shown in FIG. 3E.

At 218, a query generator is executed to automatically generate one or more queries for the selected tables of the backend databases as shown at 220. Various prompts can be utilized for the query generator to the LLMs that are generally specific to syntax and a given table as would be apparent to one of ordinary skill in the art in view of the disclosed embodiments.

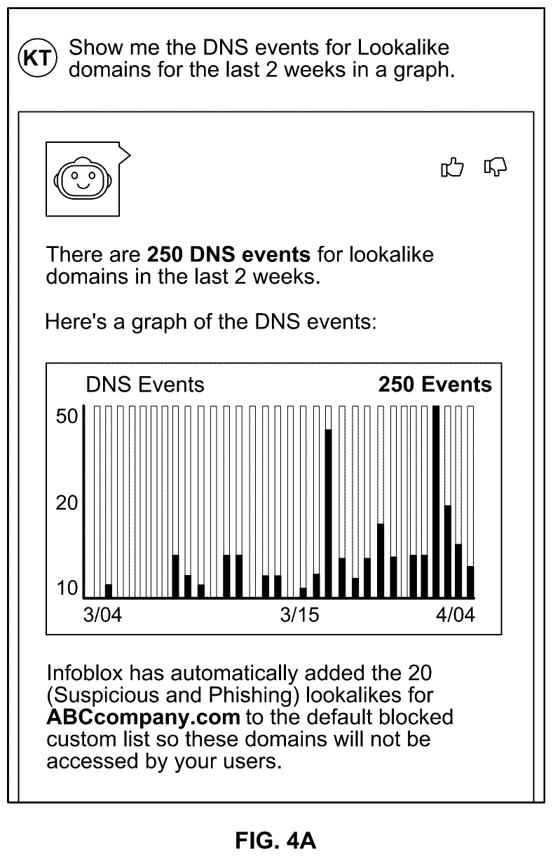

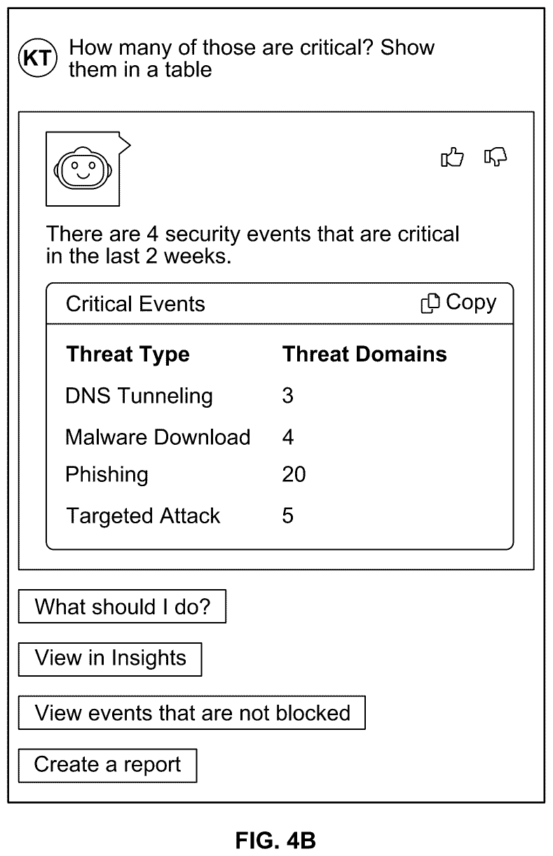

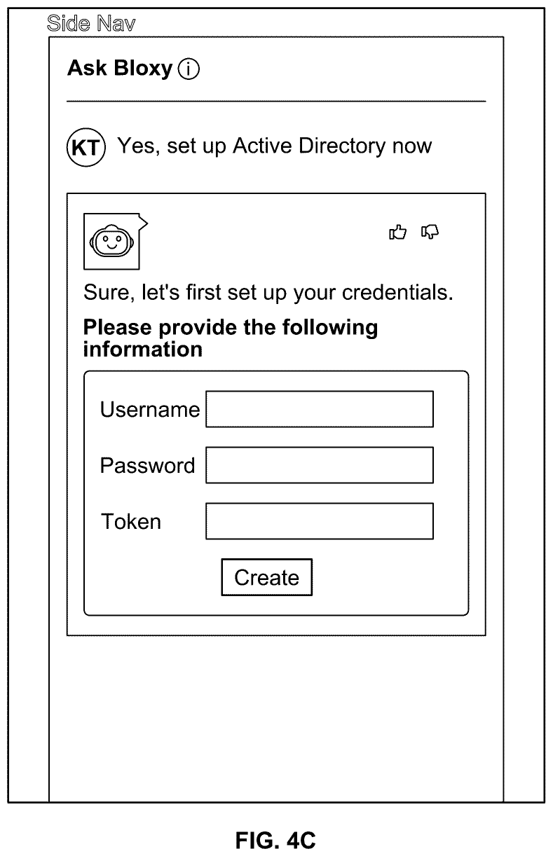

At 222, a response generator is executed to automatically generate a response based on the database query results. As further described herein, the generated response can be output in an automatically generated user interface (UI) (e.g., as shown at 140 in FIG. 1) that can include various data and UI elements, such as will be further described below with respect to various embodiments and example UI elements (e.g., as shown in FIGS. 4A-4C as further described below). An example prompt for prompt engineering of LLMs for the response generator operation is shown in FIG. 3E.

FIGS. 3A-3F illustrate various prompts for prompt engineering of LLMs for implementing Bloxy for DDI in accordance with some embodiments.

FIG. 3A illustrates an example prompt for prompt engineering of LLMs for the condenser operation in accordance with some embodiments. In this example implementation, this prompt facilitates providing a condenser that can process the conversation history to generate (e.g., output) a query or a message that incorporates the relevant context, such as similarly described above with respect to FIG. 2.

FIG. 3B illustrates an example prompt for prompt engineering of LLMs for the intent classifier operation in accordance with some embodiments. In this example implementation, this prompt provides for the intent classifier to describe, for example, a few set of capabilities, and asks the model to select one of multiple choices (e.g., this is similar to function calling, but leverages logprobs (e.g., allowing for computing the joint probability of a sequence as the sum of the logprobs of the individual tokens, see, e.g., https://cookbook.openai.com/examples/using_logprobs)) to allow for nuanced handling of ambiguous questions, such as similarly described above with respect to FIG. 2.

FIG. 3C illustrates an example prompt for prompt engineering of LLMs for the intent clarifier operation in accordance with some embodiments. In this example implementation, this prompt provides for the intent clarifier to seek to gracefully ask users for more information when it is not clear what they want from the chat assistant, such as similarly described above with respect to FIG. 2.

FIG. 3D illustrates an example prompt for prompt engineering of LLMs for the RAG Q&A operation in accordance with some embodiments. In this example implementation, this prompt provides reference to documentation to the language model (e.g., LLM/SLM) and asks it to answer the question and to provide source links, such as similarly described above with respect to FIG. 2.

FIG. 3E illustrates an example prompt for prompt engineering of LLMs for the table selector operation in accordance with some embodiments. In this example implementation, this prompt provides a table schema and description to the language model (e.g., LLM/SLM) and asks it to determine whether the table can answer the analytical question (e.g., which can facilitate minimizing compute related costs by allowing use of smaller, less expensive models/LLMs or SLMs), such as similarly described above with respect to FIG. 2.

FIG. 3F illustrates an example prompt for prompt engineering of LLMs for the response generator operation in accordance with some embodiments. In this example implementation, this prompt receives as input the output from the database query, and asks the language model (e.g., LLM/SLM) to turn it into a plain language answer for the question (e.g., generate the response), such as similarly described above with respect to FIG. 2.

FIGS. 4A-4C illustrate screen diagrams generated using Bloxy for DDI in accordance with some embodiments. As shown in these example screen diagrams, various widgets can be displayed inline, and UI elements, such as dialogue boxes and wizards, can be automatically generated on demand. As such, this provides users a familiarity and level of comfort when making changes and facilitates avoiding reliance on LLMs to make API calls, which are still an area of weakness for existing LLMs. Additional UI elements including interactive elements, widgets, and/or other UI elements are further described below.

As such, the disclosed Bloxy for DDI solution is significantly more than a text-based chat interface. For example, Bloxy for DDI can also include interactive elements, such as clickable responses, clickable follow-up questions, tables, graphs, and widgets. Clickable responses make interactions smooth and responsive, save the user typing of repetitive or expected responses, and allow for efficient backend processing. Suggested follow up questions can help aid the imagination of the user, and provide contextual suggestions based on the conversation history as well as the location inside the broader Cloud Services Portal (CSP). Tables and graphs allow Bloxy for DDI to communicate numerical and tabular data more efficiently, allowing data to be easily copied for transportation to other systems, or creating graphs within the interface itself to allow for quick analysis or report building. Finally, widgets can be presented in-line within the chat interface to provide an intuitive mechanism for gathering information necessary to make changes to a user's configurations.

In-line widgets represent a major breakthrough in AI assistant interfaces (e.g., using AI tools, such as LLMs and/or SLMs as described herein). For queries that require leveraging APIs to accomplish tasks, today's state of the art approaches boast at best around an 80% accuracy when using an LLM. This is typically sufficient if the task in question is, for example, adding songs to playlists or items to a cart, but is generally not sufficient for managing network configurations, for example, as in the disclosed Bloxy for DDI solution, in which high availability is of significant importance.

Generally, LLMs are relatively effective at choosing tools to accomplish tasks based on their description. As such, the disclosed Bloxy for DDI solution that includes a generative User Interface (UI) as described herein, facilitates leveraging the tool selection power of LLMs to retrieve and render in chat prebuilt UI elements in the form of, for example, widgets, such as similarly described above.

The advantages here of such a generative UI are at least threefold.

First, forms are significantly more natural than chat messages for relaying multiple pieces of information quickly.

Second, a prebuilt UI element can be relied upon to consistently make the correct API calls to make the changes desired, without the risk of LLM hallucinations yielding unintended results.

Third, users are familiar with UI elements, and will have a better intuitive sense of what changes are being made when they interact with a widget rather than the opacity of an AI assistant making a change for them.

To get a sense of the scope of DDI solutions, AWS Route 53 currently offers more than 175 API endpoints for interaction, and Infoblox's BloxOne solution contains greater than 200 pages for configuring, monitoring, and managing a network. As a result, it is generally very difficult for any one person, or even a small team, to become an expert in all of these capabilities, and even once they achieve mastery, they may find themselves in more senior or leadership roles that no longer see them utilizing their knowledge of the tools.

In contrast, an AI-based solution, such as the disclosed Bloxy for DDI solution, has no difficulty consuming such technical DDI related documentation that allows it to learn best practices and use cases for every page and endpoint. With such a system, any user can ask a question and be directed to relevant pages or endpoints.

In an example implementation, when used in a web interface, Bloxy for DDI is aware of the current page and is capable of suggesting questions to the user to deepen their knowledge of its capabilities or best practices for configuration. In this way, Bloxy for DDI reduces the burden of knowledge necessary to leverage the potential of the software. Even advanced users will find benefit from the assistant in its ability to accomplish tasks quickly and recall tasks completed in the past for easy retrieval and repetition.

Though there are many different tasks that can be accomplished within the Bloxy for DDI interface, they are seamlessly integrated so that a user can speak naturally with Bloxy for DDI and have the desired interaction. The system is able to detect different intents and respond accordingly, for example, if a user asks the following: “how do I add a domain to my block list,” then the disclosed Bloxy for DDI solution would respond with instructions guiding the user to their intended action. However, if the user instead says the following: “I'd like to add a domain to my block list,” then the disclosed Bloxy for DDI solution would allow the user to make the change within the chat interface.

Over time, the disclosed Bloxy for DDI solution can learn the habits and behaviors of each individual user, and personalize the experience accordingly (e.g., utilizing the relevant user's conversation history stored in the conversation history database as similarly described above with respect to FIG. 1). Examples of such personalization include, but are not limited to, the following.

As a first example, if a user consistently changes a set of configurations on a set schedule, Bloxy for DDI will ask if they would like that set of changes to be automated.

As a second example, if users have a data search that they frequently perform, then this can be pulled and presented for them on entry rather than waiting for their request.

As a third example, Bloxy for DDI can gain a knowledge of the user's role based on past interactions, and can then surface insights and suggest responses that are aligned with the user's role.

As a fourth example, Bloxy for DDI can save past interactions into their own unique chats, and the user can recall them at will (e.g., user may repeat a workflow, such can be captured and presented to the user to automate).

Overall, Bloxy for DDI can increase the productivity of users, reducing the amount of time and experience required to manage a network, such as will be further described below.

As such, Bloxy for DDI provides a personalized, task-oriented user interface (UI) (e.g., using a generative UI) that leverages LLM and other technologies to determine, based on user input, a path to solve a particular problem or perform a particular task. The inclusion of task specific inline widgets based on the user's goals saves time for the user, avoiding movement between various tools, and decreases the likelihood of hallucination associated with LLM solutions. The widgets themselves may include further AI or may provide forms to perform a specific task.

For example, the prompt “I would like to add a domain to my block list.” or “I would like to add a new subnet to my network” can retrieve a specific form for the user, as a widget within the Bloxy UI. Once completed, the system would perform the action for them.

As another example, the prompt “How do I change my network configuration?” can search and summarize documentation, and then offer the ability to create the task. It can also offer from the start whether they would like documentation or to accomplish a task.

As yet another example, the prompt “What does my threat landscape look like?” or “what are my biggest threats?” can kick-off a backend combination of analytics and language modeling to provide a cohesive story to the user based on network data.

Additional example process embodiments for building linguistic operational expert systems (Bloxy) for DNS, DHCP, and IPAM (DDI) will now be further described below.

### Example Process Embodiments for Building Linguistic Operational Expert Systems (Bloxy) for DNS, DHCP, and IPAM (DDI)

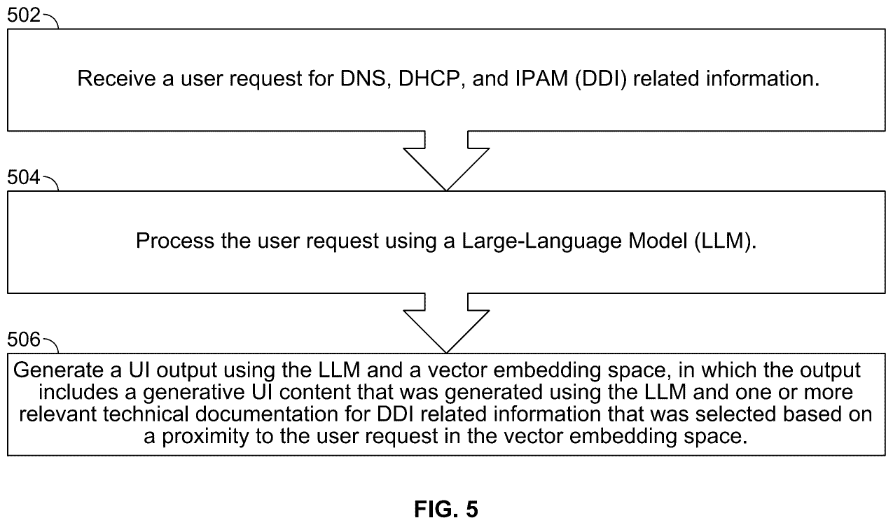

FIG. 5 is a flow diagram of a process using the Bloxy for DDI solution in accordance with some embodiments. In some embodiments, a process as shown in FIG. 5 is performed by a Bloxy for DDI solution and techniques as similarly described above including the embodiments described above with respect to FIGS. 1-4C.

At 502, a user request for DNS, DHCP, and IPAM (DDI) related information is received, such as similarly described above with respect to FIGS. 1-4C.

At 504, processing the user request using a Large-Language Model (LLM) is performed, such as similarly described above with respect to FIGS. 1-4C.

At 506, a user interface (UI) output is automatically generated using the LLM and a vector embedding space, in which the output includes generative UI content that was generated using the LLM and one or more relevant technical documentation for DDI related information that was selected based on a proximity to the user request in the vector embedding space, such as similarly described above with respect to FIGS. 1-4C.

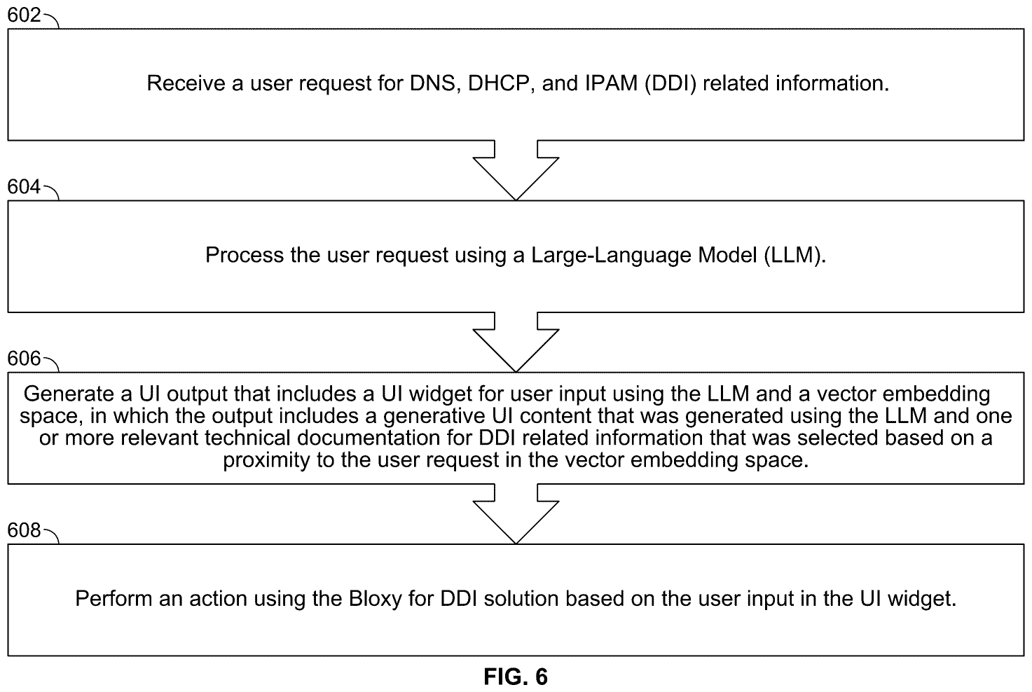

FIG. 6 is another flow diagram of a process using the Bloxy for DDI solution in accordance with some embodiments. In some embodiments, a process as shown in FIG. 6 is performed by a Bloxy for DDI solution and techniques as similarly described above including the embodiments described above with respect to FIGS. 1-4C.

At 602, a user request for DNS, DHCP, and IPAM (DDI) related information is received, such as similarly described above with respect to FIGS. 1-4C.

At 604, processing the user request using a Large-Language Model (LLM) is performed, such as similarly described above with respect to FIGS. 1-4C.

At 606, a user interface (UI) output that includes a UI widget for user input is automatically generated using the LLM and a vector embedding space, in which the output includes generative UI content that was generated using the LLM and one or more relevant technical documentation for DDI related information that was selected based on a proximity to the user request in the vector embedding space, such as similarly described above with respect to FIGS. 1-4C.

At 608, an action is performed using the Bloxy for DDI solution based on the user input in the UI widget, such as similarly described above with respect to FIGS. 1-4C.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A system, comprising:
a processor configured to:
receive a user request for DNS, DHCP, and IPAM (DDI) related information;
process the user request using a Large-Language Model (LLM); and
generate a user interface (UI) output using the LLM and a vector embedding space, wherein the output includes generative UI content that was generated using the LLM and one or more relevant technical documentation for DDI related information that was selected based on a proximity to the user request in the vector embedding space; and
a memory coupled to the processor and configured to provide the processor with instructions.

2. The system recited in claim 1, wherein the user request includes a user query for DDI related information associated with the user's enterprise network.

3. The system recited in claim 1, wherein the DDI related information includes customer information including network configuration information, network event data, and/or telemetry and log data.

4. The system recited in claim 1, wherein a conversation history is stored for a plurality of user requests.

5. The system recited in claim 1, wherein an embedding model is used for determining relevant DDI documentation based on the user request.

6. The system recited in claim 1, wherein the UI output includes one or more of the following interactive elements: clickable responses, clickable follow-up questions, tables, graphs, and widgets.

7. The system recited in claim 1, wherein the UI output includes a UI widget for user input, and wherein the processor is further configured to:
perform an action based on the user input in the UI widget.

8. The system recited in claim 1, wherein the processor is further configured to:
process a conversation history and generate a query or a message that incorporates a relevant context using the LLM.

9. The system recited in claim 1, wherein the processor is further configured to:
classify an intent associated with the user request using the LLM.

10. The system recited in claim 1, wherein the processor is further configured to:
perform retrieval augmented generation for using a vector database for DDI related technical documentation.

11. A method, comprising:
receiving a user request for DNS, DHCP, and IPAM (DDI) related information;
processing the user request using a Large-Language Model (LLM); and
generating a user interface (UI) output using the LLM and a vector embedding space, wherein the output includes generative UI content that was generated using the LLM and one or more relevant technical documentation for DDI related information that was selected based on a proximity to the user request in the vector embedding space.

12. The method of claim 11, wherein the user request includes a user query for DDI related information associated with the user's enterprise network.

13. The method of claim 11, wherein the DDI related information includes customer information including network configuration information, network event data, and/or telemetry and log data.

14. The method of claim 11, wherein a conversation history is stored for a plurality of user requests.

15. The method of claim 11, wherein an embedding model is used for determining relevant DDI documentation based on the user request.

16. The method of claim 11, wherein the UI output includes one or more of the following interactive elements: clickable responses, clickable follow-up questions, tables, graphs, and widgets.

17. The method of claim 11, wherein the UI output includes a UI widget for user input, and further comprising:
performing an action using based on the user input in the UI widget.

18. A computer program product embodied in a non-transitory computer readable medium and comprising computer instructions for:
receiving a user request for DNS, DHCP, and IPAM (DDI) related information;
processing the user request using a Large-Language Model (LLM); and
generating a user interface (UI) output using the LLM and a vector embedding space, wherein the output includes generative UI content that was generated using the LLM and one or more relevant technical documentation for DDI related information that was selected based on a proximity to the user request in the vector embedding space.

19. The computer program product recited in claim 18, wherein the user request includes a user query for DDI related information associated with the user's enterprise network.

20. The computer program product recited in claim 18, wherein DDI related information includes customer information including network configuration information, network event data, and/or telemetry and log data.
